(19) United States
(12) Patent Application Publication
(10) Pub. No.: US 2026/0133732 A1
(43) Pub. Date: May 14, 2026

(54) IMAGE FORMING APPARATUS, IMAGE FORMING SYSTEM, CONTROL METHOD FOR IMAGING FORMING APPARATUS, AND CONTROL PROGRAM FOR IMAGE FORMING APPARATUS

(71) Applicant: Konica Minolta, Inc., Tokyo (JP)

(72) Inventor: Ryousuke OKAJIMA, Tokyo (JP)

(21) Appl. No.: 19/382,736

(22) Filed: Nov. 7, 2025

(30) Foreign Application Priority Data
Nov. 8, 2024 (JP) 2024-195886

(51) Int. Cl. G06F 3/12; G06K 15/00

(52) U.S. Cl. CPC G06F 3/1251; G06F 3/1208; G06K 15/4065

(57) ABSTRACT

An image forming apparatus of a roll-to-roll type according to the present invention includes a hardware processor functioning as a controller that is capable of receiving an instruction to execute a print job according to printing of repeatedly printing a document image for which an output print length has been specified by an user and that, when receiving the instruction to execute the print job, causes the printing of the document image to be executed on a roll sheet, which is conveyed, a number of repetitions corresponding to the specified output print length.

### CROSS REFERENCE TO RELATED APPLICATIONS

The present invention claims priority under 35 U.S.C. § 119 Japanese Patent Application No. 2024-195886, filed on Nov. 8, 2024, the entire contents of which being incorporated herein by reference.

### BACKGROUND

### Technological Field

The present disclosure relates to an image forming apparatus, an image forming system, a control method for the image forming apparatus, and a control program for the image forming apparatus.

### Description of Related Art

In the related art, there is known an image forming apparatus of a roll-to-roll type (also referred to as a roll machine) that uses a roll sheet as a recording medium and forms an image on the roll sheet. See, for example, Japanese Patent Publication Laid-Open No. 2024-74530.

Incidentally, the image forming apparatus of this type is used, for example, for an application of repeatedly printing a label image of the same design on a roll sheet (e.g., a long sheet in which a label sheet is pasted to a backing sheet), or the like. In addition, the roll sheet on which a label image has been repeatedly printed is commercially available, for example, as a masking tape or the like.

FIG. 1 is a diagram illustrating an example of an aspect of label image printing on a roll sheet. In FIG. 1, each of pages P11 to P15 corresponds to a region on which the same label image has been printed. The length of the region of each page in the conveyance direction is set, for example, based on the image vertical size of the label image in the sheet conveyance direction.

Generally, the roll sheet of this type is often commercially available in a state in which the sheet length of the roll sheet is defined (e.g., sheet length: 30 m or the like) regardless of the design of the label image. For this reason, printing on the roll sheet of this type often is performed in view of the output print length (which means the sheet length for which printing is executed; the same applies hereinafter) that is matched to the actual sheet length of the roll sheet.

In this regard, the image forming apparatus according to the prior art is set to cause a print job to be specifiable only with the number of pages to be printed. For this reason, in a case where printing is executed only for a desired sheet length, the user himself/herself has to calculate the required number of pages to be printed based on the image size of the label image and to set the calculated number of pages to be printed to a print job. Note that, the image size of the label image typically varies depending on the design of the label image. For the user, such calculation work is complicated, and in a case where the output print length is different from the actual sheet length, such a printed product may be a defective product.

### SUMMARY

The present invention has been made in consideration of the above-described problems. That is, it is an object of the present invention to provide an image forming apparatus which enables the user to specify a desired output print length and execute printing when repeatedly printing an image on a roll sheet. In addition, in another aspect, it is an object of the present invention to provide an image forming system including the image forming apparatus. In addition, in another aspect, it is an object of the present invention is to provide a control method for the image forming apparatus. In addition, in another aspect, it is an object of the present invention to provide a control program for the image forming apparatus.

To achieve at least one of the abovementioned objects, according to an aspect of the present invention, the image forming apparatus reflecting one aspect of the present invention is an image forming apparatus of a roll-to-roll type comprising:
a hardware processor functioning as a controller that is capable of receiving an instruction to execute a print job according to printing of repeatedly printing a document image for which an output print length has been specified by an user and that, when receiving the instruction to execute the print job, causes the printing of the document image to be executed on a roll sheet, which is a roll sheet to be conveyed, a number of repetitions corresponding to the specified output print length.

Further, the image forming system reflecting another aspect of the present invention is an image forming system comprising:
an external terminal apparatus that gives an instruction to execute the print job; and
the image forming apparatus described above.

Further, the control method reflecting another aspect of the present invention is a control method for an image forming apparatus of a roll-to-roll type.

The method enables reception of an instruction to execute a print job according to printing of repeatedly printing a document image for which an output print length has been specified by an user, and the method comprises, when receiving the instruction to execute the print job, executing the printing of the document image on a roll sheet, which is a roll sheet to be conveyed, a number of repetitions corresponding to the specified output print length.

Further, the non-transitory recording medium storing therein computer-readable program reflecting another aspect of the present invention is a non-transitory recording medium storing therein computer-readable program for an image forming apparatus of a roll-to-roll type.

The control program enables reception of an instruction to execute a print job according to printing of repeatedly printing a document image for which an output print length has been specified by an user, and the control program causes a computer to execute, when receiving the instruction to execute the print job, the printing of the document image on a roll sheet, which is a roll sheet to be conveyed, a number of repetitions corresponding to the specified output print length.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating an example of an aspect of label image printing on a roll sheet;

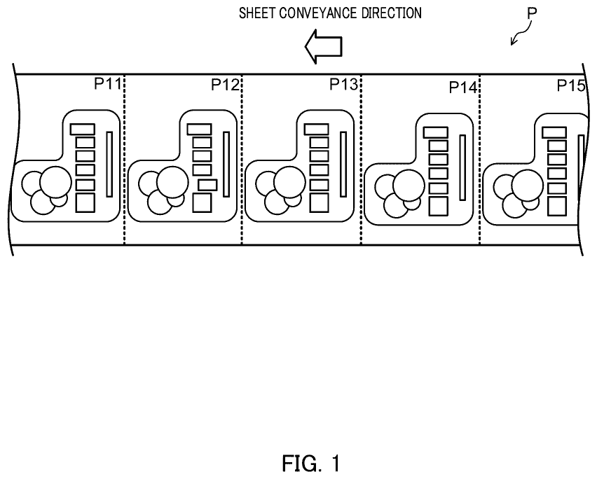

FIG. 2 is a diagram schematically illustrating an overall configuration of an image forming apparatus according to an embodiment of the present invention;

FIG. 3 is a diagram illustrating a main configuration of a control system of an image forming unit included in the image forming apparatus according to an embodiment of the present invention;

FIG. 4 is a diagram illustrating an exemplary functional configuration that a controller in the image forming apparatus according to an embodiment of the present invention has for executing repeated printing;

FIG. 5 is a diagram illustrating an example of image data of a document image;

FIG. 6 is a diagram illustrating an example of an operation screen for specifying the job content of a print job in the image forming apparatus according to an embodiment of the present invention;

FIG. 7A, FIG. 7B, and FIG. 7C are diagrams provided for describing “fit”, “overlap”, and “before” in a method of processing a print tail end in the image forming apparatus according to an embodiment of the present invention;

FIG. 8 is a flowchart illustrating an example of processing of the controller in the image forming apparatus according to an embodiment of the present invention;

FIG. 9 is a diagram illustrating an example of the operation screen for specifying the job content of a print job in the image forming apparatus according to Variation 1;

FIG. 10A and FIG. 10B are diagrams provided for describing a method of processing a print width end in an N-up function in the image forming apparatus according to Variation 1;

FIG. 11 is a flowchart illustrating an example of processing of the controller in the image forming apparatus according to Variation 1;

FIG. 12 is a diagram illustrating an example of the operation screen for specifying the job content of a print job in the image forming apparatus according to Variation 2; and

FIG. 13 is a flowchart illustrating an example of processing of the controller in the image forming apparatus according to Variation 3.

### DETAILED DESCRIPTION OF EMBODIMENTS

Hereinafter, one or more embodiments of the present invention will be described with reference to the drawings. However, the scope of the invention is not limited to the disclosed embodiments.

### Overall Configuration of Image Forming Apparatus

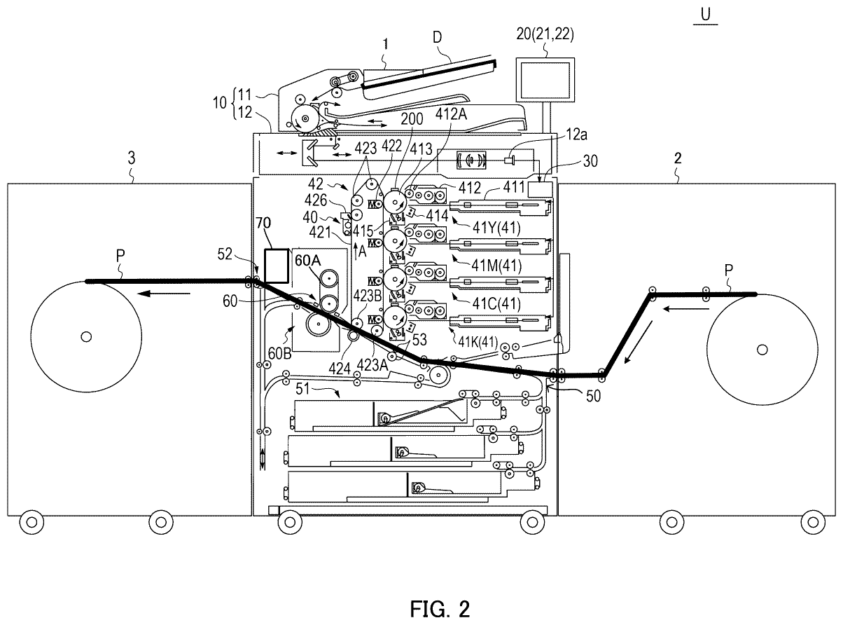

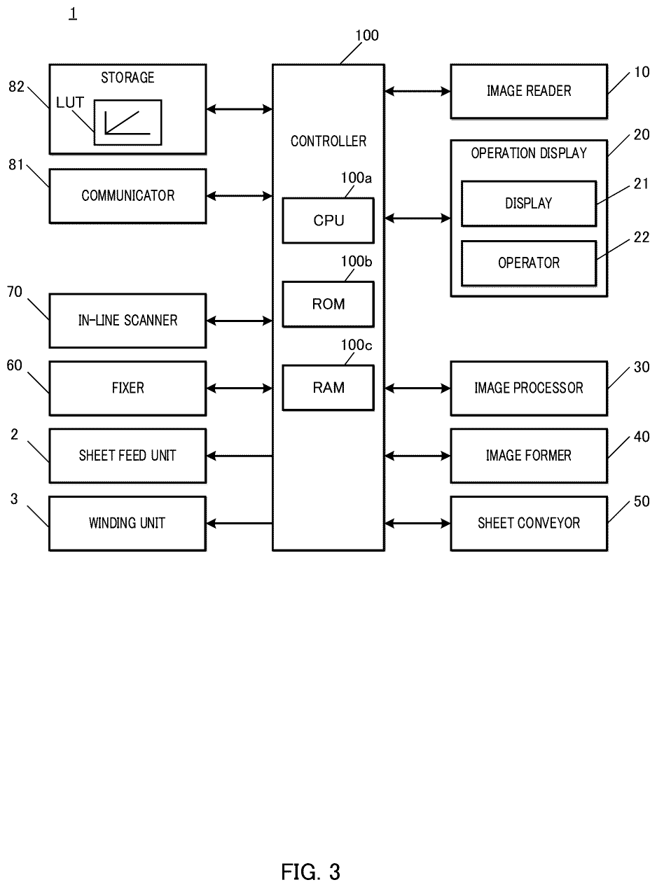

Hereinafter, an exemplary configuration of an image forming apparatus (hereinafter, referred to as “the image forming apparatus U”) according to an embodiment of the present invention will be described with reference to FIG. 2 and FIG. 3. Note that, although an aspect in which a label image is repeatedly printed on a roll sheet will be indicated as an example of the image forming apparatus U in the present embodiment, an image to be printed is not limited to a label image.

FIG. 2 is a diagram schematically illustrating an overall configuration of the image forming apparatus U. FIG. 3 is a diagram illustrating a main configuration of a control system of an image forming unit 1 included in the image forming apparatus U.

The image forming apparatus U is an image forming apparatus of a roll-to-roll type that uses a roll sheet P as a recording medium and forms an image on the roll sheet P. Note that, the type of the sheet used as the roll sheet P is arbitrary. Here, for example, and a label sheet is used as an application of a masking tape or the like.

The image forming apparatus U is formed by connecting a sheet feed unit 2, the image forming unit 1, and a winding unit 3 from the upstream side along the conveyance direction of the roll sheet P.

The sheet feed unit 2 is an apparatus that feeds the roll sheet P to the image forming unit 1. In the housing of the sheet feed unit 2, the roll sheet P is wound in a roll shape around a support shaft and is rotatably held. The sheet feed unit 2 conveys the roll sheet P wound around the support shaft to the image forming unit 1 at a constant speed via, for example, a plurality of pairs of conveyance rollers such as feeding-out rollers and sheet feed rollers. The sheet feeding operation of the sheet feed unit 2 is controlled by a controller 100 included in the image forming unit 1.

The image forming unit 1 forms a color image by utilizing an electrophotographic process technology. That is, the image forming unit 1 primary-transfers toner images of colors of yellow (Y), magenta (M), cyan (C), and black (K) formed on photosensitive drums 413 onto an intermediate transfer belt 421. In addition, after the toner images of the four colors are superimposed on one another on the intermediate transfer belt 421, the resultant toner image is secondarily-transferred onto the roll sheet P fed from the sheet feed unit 2 to form a color image on the roll sheet P.

In addition, the image forming unit 1 adopts a tandem-system in which the photosensitive drums 413 corresponding to the four colors of Y, M, C, and K are arranged in series in the travel direction of the intermediate transfer belt 421, and the toner images of the respective toner colors are sequentially transferred onto the intermediate transfer belt 421 by a single procedure.

The image forming unit 1 includes an image reader 10, an operation display 20, an image processor 30, an image former 40, a sheet conveyor 50, a fixer 60, an in-line scanner 70, a communicator 81, a storage 82, and the controller 100.

The controller 100 includes a CPU 100a, a ROM 100b, a RAM 100c, and the like. The CPU 100a reads a program according to the processing content from the ROM 100b, develops the program in the RAM 100c, and performs centralized control of the operation of each block and the like of the image forming unit 1 in conjunction with the developed program. At this time, various types of data stored in the storage 82 are referred to. The storage 82 is constituted by, for example, a non-volatile semiconductor memory (so-called flash memory) and/or a hard disk drive.

The controller 100 transmits and receives various data to and from an external terminal apparatus (for example, a personal computer (not illustrated)) connected to a network such as a LAN or a WAN via the communicator 81. For example, the controller 100 receives image data transmitted from the external terminal apparatus and causes an image to be formed on the roll sheet P based on the image data. The communicator 81 is constituted by a communication control card such as a LAN card.

The image reader 10 includes an automatic document image feeding apparatus 11 called an ADF, a document image scanning apparatus 12, and the like.

The automatic document image feeding apparatus 11 conveys a document image D, which has been placed on a document image tray, by a conveyance mechanism and feeds out the document image D to the document image scanning apparatus 12. The automatic document image feeding apparatus 11 makes it possible to continuously and collectively read images of a large number of document images D placed on the document image tray.

The document image scanning apparatus 12 optically scans a document image conveyed from the automatic document image feeding apparatus 11 onto a contact glass or a document image placed on the contact glass, forms an image of reflected light from the document image on a light receiving surface of a CCD sensor 12a, and reads the document image. The image reader 10 generates input image data based on a reading result by the document image scanning apparatus 12. The input image data undergoes predetermined image processing at the image processor 30.

The operation display 20 is constituted by, for example, a liquid crystal display with a touch screen, and functions as a display 21 and an operator 22. The display 21 displays various operation screens, the state of the image, the operation status of each function, information on printing, and the like according to a display control signal inputted from the controller 100. The operator 22 includes various operation keys such as a numeric keypad, and a start key, receives various input operations by the user, and outputs an operation signal to the controller 100.

The image processor 30 includes a circuit or the like that performs digital image processing corresponding to initial settings or user settings on input image data. For example, the image processor 30 performs gradation correction based on gradation correction data under the control of the controller 100. The image processor 30 performs, in addition to the gradation correction, various types of correction processing such as color correction and shading correction, compression processing, and the like on the input image data. The image former 40 is controlled based on the image data on which the above-described pieces of processing have been performed.

The image former 40 includes toner image forming units 41Y, 41M, 41C, and 41K for forming images with color toners of Y, M, C, and K components based on the input image data, an intermediate transfer unit 42, and the like.

The toner image formers 41Y, 41M, 41C, and 41K for the Y, M, C, and K components have a similar configuration. For convenience of illustration and description, common constituent elements are denoted by the same reference signs, and in a case where the common constituent elements are distinguished from each other, Y, M, C, or K is added to the reference signs. In FIG. 2, reference signs are assigned to only the constituent elements of the toner image former 41Y for the Y constituent elements and the reference signs of the constituent elements of the other toner image formers 41M, 41C, 41K are omitted.

The toner image forming unit 41 includes an exposure apparatus 411, a developing apparatus 412, a photosensitive drum 413, a charging apparatus 414, a drum cleaning apparatus 415, a toner collector 200, and the like.

The photosensitive drum 413 is made of, for example, an organic photoreceptor in which a photosensitive layer made of a resin containing an organic photoconductor is formed on an outer periphery surface of a drum-shaped metal base. Note that, the controller 100 controls a drive current supplied to a drive motor that rotates the photosensitive drum 413 to rotate the photosensitive drum 413 at a constant peripheral speed.

The charging apparatus 414 is, for example, a charging charger, and uniformly charges the surface of the photosensitive drum 413 having photoconductivity to a negative polarity by generating corona discharge.

The exposure apparatus 411 is constituted by, for example, a semiconductor laser, and emits laser light corresponding to an image of each toner color component to the photosensitive drum 413. As a result, in the surface of the photosensitive drum 413, due to a potential difference from the background region, an electrostatic latent image of each toner color component is formed on the image region to which the laser light is emitted.

The developing apparatus 412 is a developing apparatus of a two-component reverse rotation type, and visualizes an electrostatic latent image and develops the visualized electrostatic latent image as a toner image by causing a developer of each toner color component to adhere to the surface of the photosensitive drum 413.

A developing roller 412A included in the developing apparatus 412 bears the developer while rotating, and supplies a toner included in the developer to the photosensitive drum 413. Specifically, the developing roller 412A forms a toner image on the surface of the photosensitive drum 413 by application of developing bias from a developing bias applier 412B and generation of a potential difference between the developing roller 412A and the surface of the photosensitive drum 413.

The drum cleaning apparatus 415 is caused to abut on the surface of the photosensitive drum 413, includes a plate-shaped cleaning blade or the like having elasticity, and removes a toner not transferred onto the intermediate transfer belt 421 and remaining on the surface of the photosensitive drum 413.

The intermediate transfer unit 42 includes the intermediate transfer belt 421, primary transfer rollers 422, a plurality of support rollers 423, a secondary transfer roller 424, a belt cleaning apparatus 426, and the like.

The intermediate transfer belt 421 is formed of an endless-shaped belt and is stretched in a loop over the plurality of support rollers 423. At least one of the plurality of support rollers 423 is constituted by a drive roller, and the other support roller(s) 423 is/are constituted by a driven roller(s). For example, a roller 423A disposed on the downstream side of the primary transfer roller 422 for the K component in the belt travel direction is preferably a drive roller. Thus, the travel speed of the belt at a primary transfer section is easily kept constant. The rotation of the drive roller 423A causes the intermediate transfer belt 421 to travel in the direction of an arrow A at a constant speed.

The intermediate transfer belt 421 is a belt having conductivity and elasticity and has a high-resistance layer on the surface thereof. The intermediate transfer belt 421 is rotationally driven by a control signal from the controller 100.

The primary transfer roller 422 is disposed on the side of the inner periphery surface of the intermediate transfer belt 421 with the primary transfer roller 422 facing the photosensitive drum 413 of each toner color component. The primary transfer roller 422 is brought into pressure contact with the photosensitive drum 413 with the intermediate transfer belt 421 held therebetween, thereby forming a primary transfer nip for transferring a toner image from the photosensitive drum 413 onto the intermediate transfer belt 421.

The secondary transfer roller 424 is disposed on the side of the outer peripheral surface of the intermediate transfer belt 421 with the secondary transfer roller 424 facing a backup roller 423B disposed on the downstream side of the drive roller 423A in the belt travel direction. The secondary transfer roller 424 is brought into pressure contact with the backup roller 423B with the intermediate transfer belt 421 held therebetween, thereby forming a secondary transfer nip for transferring a toner image from the intermediate transfer belt 421 onto the roll sheet P.

When the intermediate transfer belt 421 passes through each of the primary transfer nips, the toner images on the photosensitive drums 413 are sequentially superimposed and primary-transferred onto the intermediate transfer belt 421. Specifically, the toner images are electrostatically transferred onto the intermediate transfer belt 421 by applying primary transfer bias to the primary transfer roller 422 and applying electric charge having an opposite polarity of the toner to the side of the back surface of the intermediate transfer belt 421, that is, a side on which the primary transfer roller 422 abuts.

Thereafter, when the roll sheet P passes through the secondary transfer nip, the toner image on the intermediate transfer belt 421 is secondary-transferred onto the roll sheet P. Specifically, the toner image is electrostatically transferred onto the roll sheet P by applying secondary transfer bias to the secondary transfer roller 424 and applying electric charge having an opposite polarity of the toner to the side of the back surface of the roll sheet P, that is, the side on which the secondary transfer roller 424 abuts. The roll sheet P onto which the toner image has been transferred is conveyed toward the fixer 60.

The belt cleaning apparatus 426 removes a transfer residual toner remaining on the surface of the intermediate transfer belt 421 after the secondary transfer. Note that, instead of the secondary transfer roller 424, a so-called belt-type secondary transfer unit having a configuration in which a secondary transfer belt is stretched in a loop shape over a plurality of support rollers including a secondary transfer roller may also be employed.

The fixer 60 includes an upper-side fixer 60A, a lower-side fixer 60B, a heating source, and the like. The upper-side fixer 60A includes a fixing surface-side member that is disposed on the side of the fixing surface of the roll sheet P, that is, the side on which the toner image has been formed. The lower-side fixer 60B includes a back surface-side supporting member that is disposed on the side of the back surface of the roll sheet P, that is, the side of the surface opposite to the fixing surface. The back surface-side supporting member is brought into pressure contact with the fixing surface-side member, so that a fixing nip is formed which holds the roll sheet P and conveys the roll sheet P. The fixer 60 heats and pressurizes the conveyed roll sheet P, onto which the toner image has been secondary-transferred, at the fixing nip, thereby fixing the toner image on the roll sheet P.

The in-line scanner 70 captures and reads an image formed on the roll sheet P by, for example, a built-in CCD sensor, CMOS sensor or the like. The in-line scanner 70 is disposed, for example, at a position facing the roll sheet P on the downstream side of the fixer 60 of a conveyance route 53.

The sheet conveyor 50 includes a sheet feeder 51, a sheet ejector 52, the conveyance route 53, and the like. The conveyance route 53 includes a plurality of conveyance roller pairs and conveys the roll sheet P fed from the sheet feed unit 2 to the image former 40 and the fixer 60, and then feeds out the roll sheet P to the winding unit 3. Note that, the plurality of conveyance roller pairs in the conveyance route 53 includes a registration roller pair that corrects inclination and deviation of the roll sheet P.

Note that, the sheet feeder 51 is a sheet feeder for a plain sheet provided separately from the sheet feed unit 2 and feeds a sheet having a length that does not exceed the main body width of the image forming unit 1. In the three sheet feed tray units constituting the sheet feeder 51, sheets identified based on basis weight, size, and the like are housed for each type set in advance.

The roll sheet P fed from the sheet feed unit 2 to the image forming unit 1 is conveyed to the image former 40 by the conveyance route 53. Then, at the image former 40, the toner image on the intermediate transfer belt 421 is collectively secondary-transferred onto one surface of the roll sheet P, and a fixing process is performed at the fixer 60. The roll sheet P having on which an image has been formed is conveyed to the winding unit 3 by the sheet ejector 52 including a sheet ejection roller pair.

The winding unit 3 is an apparatus that winds up the roll sheet P conveyed from the image forming unit 1. In the housing of the winding unit 3, for example, the roll sheet P is wound around the support shaft and held in a roll shape. For this reason, the winding unit 3 winds up the roll sheet P conveyed from the image forming unit 1 around the support shaft at a constant speed via a plurality of conveyance roller pairs.

### Detailed Configuration of Controller 100

Next, a functional configuration of the controller 100 according to the present embodiment will be described. Note that, only a functional configuration for the controller 100 to execute repeated printing will be described here.

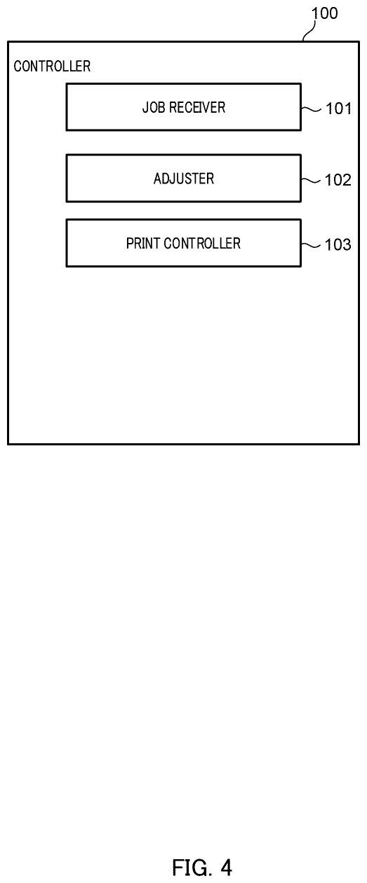

FIG. 4 is a diagram illustrating an exemplary functional configuration that the controller 100 has.

The controller 100 functions as a job receiver 101, an adjuster 102, and a print controller 103.

The job receiver 101 receives an instruction to execute a print job. Here, the job receiver 101 according to the present embodiment is configured to be capable of receiving an instruction to execute a print job according to repeated printing of a document image for which an output print length has been specified by the user. Note that, it is configured such that the user is allowed to give the instruction to execute a print job by using, for example, the operation display 20 or an external terminal apparatus (for example, an external computer (not illustrated)).

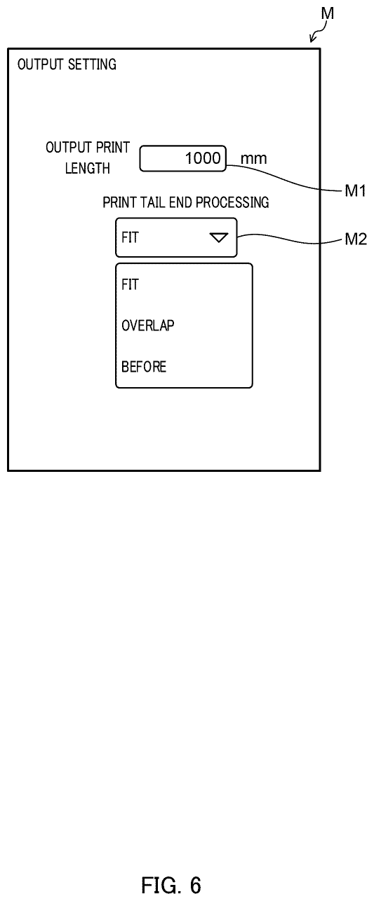

Further, it is configured such that the job receiver 101 allows the user to specify which aspect among aspects “fit”, “overlap” and “before” is to be adopted as a method of processing a print tail end in a print job (see FIG. 6). Note that, the “print tail end” means a portion corresponding to the final page of the roll sheet P when repeated printing is performed on the roll sheet P (the same applies hereinafter).

The adjuster 102 sets the number of repetitions for repeatedly printing a document image in a print job based on an image vertical size of document image (representing the image size in the conveyance direction; the same applies hereinafter) and the output print length specified for the print job. That is, when executing a print job, the adjuster 102 calculates an appropriate number of repetitions based on the output print length received by the job receiver 101 and sets the value of the appropriate number of repetitions.

For example, the adjuster 102 sets, as the number of repetitions for the print job, a value obtained by dividing the specified output print length by the image vertical size of the document image as in an equation 1 below.

{1}

The number N of repetitions=the specified output print length/the image vertical size of the document image . . . (Equation 1)

However, in a print job according to repeated printing for which an output print length has been specified, there is a case where the print tail end does not coincide with the tail end of the document image. This is because a reference print length when a document image is repeatedly printed an integer number of times (where the integral number of times represents a value obtained by performing floor division of the specified output print length by the image vertical size; the same applies hereinafter) (hereinafter, simply referred to as the reference print length) may not coincide with the specified output print length. There is a case where when printing is executed beyond a specified output print length without any setting at this time, a problem occurs in that image formation processing is executed beyond a sheet region depending on the type of printed material, or the like.

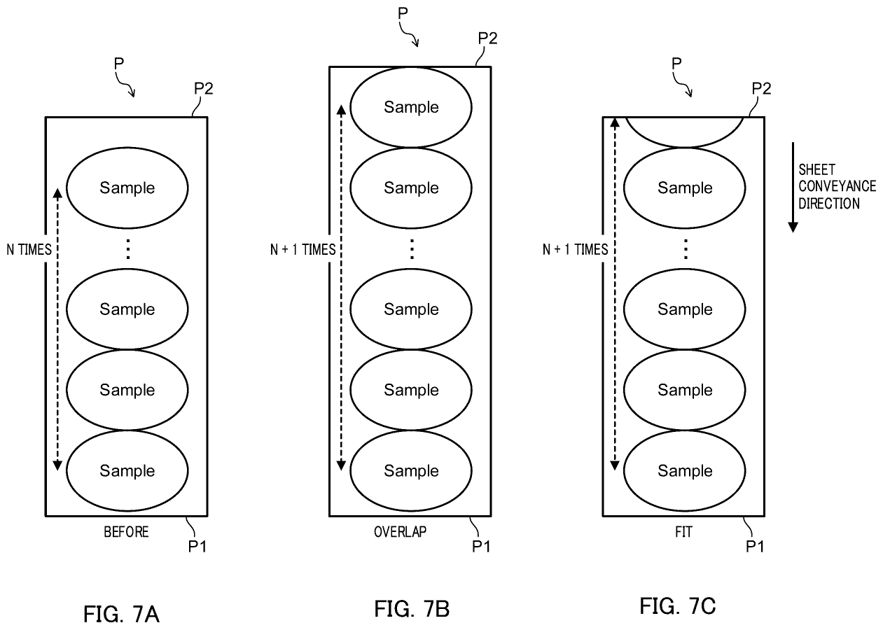

Accordingly, the adjuster 102 adjusts the number of repetitions for the document image or the like such that the print tail end is subjected to processing according to the specified item “fit”, “overlap”, or “before” received by the job receiver 101 (which will be described later with reference to FIG. 7A to FIG. 7C).

The print controller 103 causes printing of a document image to be executed on the conveyed roll sheet P in accordance with the setting content of the print job adjusted by the adjuster 102.

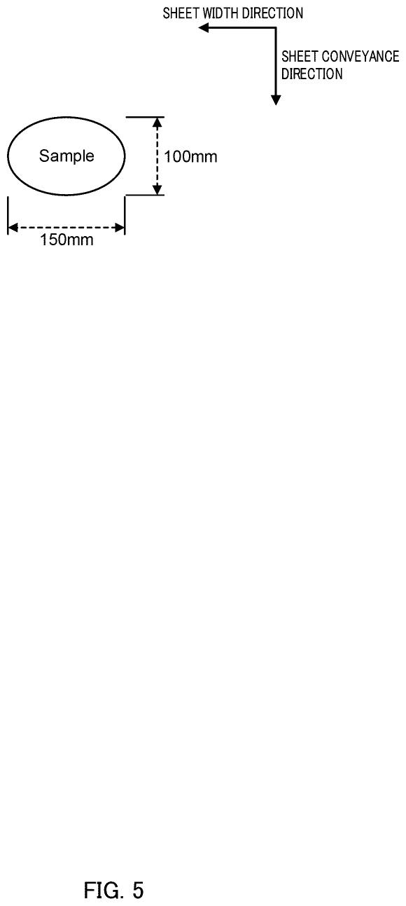

An example of processing of each function of the controller 100 will be described with reference to FIG. 5 to FIG. 7C.

FIG. 5 is a diagram illustrating an example of image data of a document image. Here, an image of “100 mm (sheet conveyance direction)×150 mm (sheet width direction)” is illustrated as an example. In repeated printing, for example, this document image's image size “100 mm (sheet conveyance direction)×150 mm (sheet width direction)” serves as the unit of one page. That is, in repeated printing, for example, printing is executed with the number of times of repeated printing of the document image as the number of printed pages. For this reason, in repeated printing, printing with the output print length of 100 mm (sheet conveyance direction)×the number of times of repeated printing is executed.

The adjuster 102 specifies, based on image data of a document image received by the job receiver 101, the image size of the document image.

In this respect, the image size of a document image as the unit of one page may be configured to be adjustable by the user such that a margin is provided for the actual document image.

Note that there is a case where the image size of a document image is defined in advance on image data. In such a case, the adjuster 102 may specify the actual image formation region on the image data of the document image by known image recognition processing and calculate the image size of the document image.

FIG. 6 is a diagram illustrating an example of an operation screen M for specifying the job content of a print job. This operation screen M is, for example, an operation screen displayed on the operation display 20 when the user transmits an instruction to register a print job together with image data of a document image from the external terminal apparatus to the image forming apparatus U.

On the operation screen M, for example, an item (text box M1) for specifying the “output print length” and an item (pull-down menu M2) for specifying the “method of processing the print tail end” are displayed. Then the user is allowed to specify the output print length as a numerical value (for example, 1000 mm) by performing numerical value inputting into the text box M1 of the operation screen M. In addition, for example, through selection from the pull-down menu M2 of the operation screen M, the user is allowed to specify one of the three aspects “fit”, “overlap”, and “before” as the method of processing the print tail end. Note that the content specified by the user on the operation screen M is received as a print job by the job receiver 101.

Note that, although not illustrated in FIG. 6, the job receiver 101 may also be allowed to receive, as a print job, repeated printing of a document image for which the normal number of copies has been specified, instead of repeated printing of a document image for which an output print length has been specified.

FIG. 7A, FIG. 7B, and FIG. 7C are diagrams provided for describing “fit”, “overlap”, and “before” in a method of processing a print tail end. As described above, this processing is a method of processing a print tail end in a case where the specified output print length does not coincide with a reference print length when the document image is repeatedly printed an integer number of times (where the integer number of times is a value obtained by performing floor division of the output print length by the image vertical size).

Note that, in FIG. 7A to FIG. 7C, P1 represents the head end of the roll sheet P to be outputted, and P2 represents the tail end of the roll sheet P to be outputted. Here, an aspect is illustrated in which an output print length that is N times or more and less than N+1 times the image vertical size of the document image has been specified by the user.

FIG. 7A is a diagram illustrating a method of processing a print tail end in a case where “before” has been specified as the method of processing the print tail end. In a case where “before” has been specified, the adjuster 102 sets the number of repetitions for the document image to the value calculated by performing floor division of the output print length specified by the user by the image vertical size of the document image and causes printing to be performed. Note that, in this method of processing a print tail end, the output print length for actual printing is shorter than the output print length specified by the user by the fraction to be rounded down by the floor division.

FIG. 7B is a diagram illustrating a method of processing a print tail end in a case where “overlap” has been specified as the method of processing the print tail end. In a case where “overlap” has been specified, the adjuster 102 sets the number of repetitions for the document image to a value calculated by ceiling division of the output print length by the image vertical size of the image data. Note that, in this method of processing a print tail end, the output print length for actual printing is longer than the output print length specified by the user by the fraction to be rounded up by the ceiling division.

FIG. 7C is a diagram illustrating a method of processing a print tail end in a case where “fit” has been specified as the method of processing the print tail end. In a case where “fit” has been specified, the adjuster 102 sets the number of repetitions for the document image to a value calculated by ceiling division of the output print length by the image vertical size of the image data. Then, the adjuster 102 calculates, for the image data of the final page, the difference between the output print length and the above-described reference print length, and corrects the image data of the final page to an image obtained by trimming the side of the leading end of the document image in the conveyance direction of the document image by the difference. Note that, in this method of processing a print tail end, the output print length for actual printing coincides with the output print length specified by the user.

### Operation Flow of Controller 100

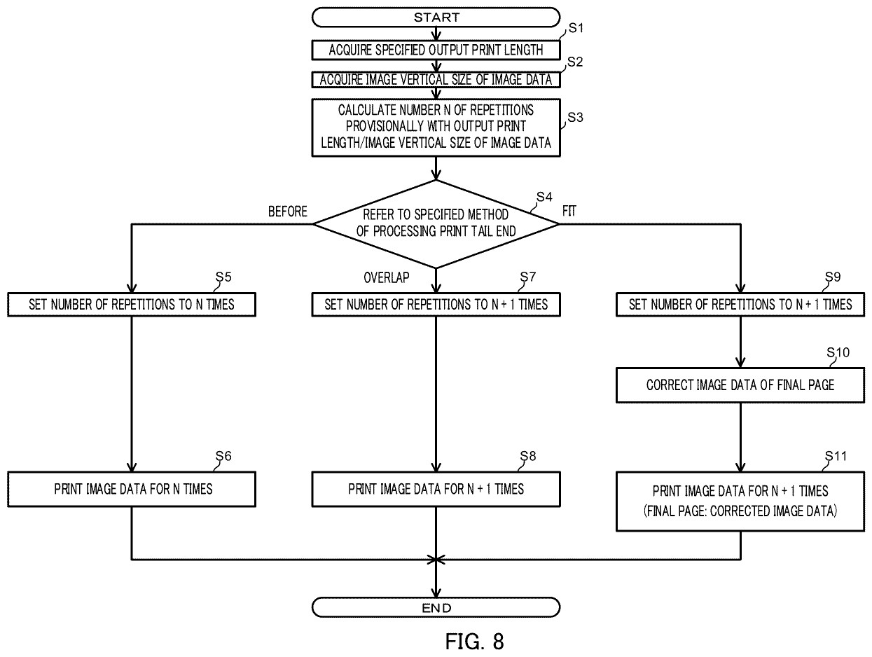

FIG. 8 is a flowchart illustrating an example of the operation of the controller 100 in a print job of repeated printing.

Here, processing when the controller 100 receives an instruction to execute a print job of repeated printing for which an output print length has been specified will be described.

Note that, the processing is started in response to an instruction to execute printing from the user. Specifically, for example, the user first transmits image data of a document image from an external terminal apparatus (for example, a personal computer used by the user) to the image forming apparatus U to register a print job. Next, on the operation screen M (i.e., the operation display 20) illustrated in FIG. 6, the user specifies the output print length and the method of processing the print tail end of an output sheet as the job content of the print job, and gives an instruction to execute the print job. That is, the print data of a print job acquired by the controller 100 includes data such as image data of a document image, image size data of the document image, an output print length, a method of processing a print tail end of an output sheet, and standard data (sheet size) of the roll sheet P as a recording medium.

Upon receiving a print job of repeated printing, the controller 100 acquires the specified output print length from the print data defining the print job (step S1). Next, the controller 100 acquires the image vertical size of the document image in the sheet conveyance direction of the document image from the print data defining the print job (step S2).

Next, the controller 100 provisionally calculates the minimum required number of repetitions of printing by performing floor division of the specified output print length by the image vertical size of the document image using the following equation 1 (step S3).

{2}

The number N of repetitions=the specified output print length/the image vertical size of the document image . . . (Equation 1)

Next, the controller 100 refers to the “method of processing the print tail end” specified in the print job (step S4).

In a case where the “before” mode has been specified here as the “method of processing the print tail end” in the print job, the controller 100 sets N times calculated by the equation 1 described above as the number of repetitions to be executed at the time of printing (step S5). Then, the controller 100 causes the image former 40 to execute printing such that the number of repetitions of printing becomes N times (step S6).

In addition, in a case where the “overlap” mode has been specified here as the “processing method for print tail end” in the print job, the controller 100 sets N+1 times, which has been obtained by incrementing the above-calculated N times by one time, as the number of repetitions to be executed at the time of printing (step S7). Then, the controller 100 causes the image former 40 to execute printing such that the number of repetitions of printing becomes N+1 (step S8).

In addition, in a case where the “fit” mode has been specified here as the “method of processing the print tail end” in the print job, the controller 100 sets N+1 times, which has been obtained by incrementing N times calculated by the above-described equation 1 by one time, as the number of repetitions to be executed at the time of printing (step S9). Then, the controller 100 subtracts N times×the image vertical size from the specified output print length to calculate the difference therebetween. Then, the controller 100 corrects the image data to be used as the final page to image data trimmed by the difference (step S10). Then, the controller 100 sets the number of repetitions of printing to N+1 times and causes the image former 40 to execute printing by using the corrected image data for the final page (step S11).

Through the above-described series of processing, the controller 100 is capable of causing repeated printing to be executed such that the actual output print length corresponds to the output print length specified by the user.

### Effects

As described above, the present embodiment discloses, as an image forming apparatus of a roll-to-roll type, an image forming apparatus comprising
a controller that is capable of receiving an instruction to execute a print job according to repeated printing of a document image for which an output print length has been specified by an user and that, when receiving the instruction to execute the print job, causes printing of the document image to be executed on a roll sheet, which is conveyed, a number of repetitions corresponding to the specified output print length.

The image forming apparatus according to the present embodiment is capable of providing a function that causes a desired output print length to be specifiable by the user at the time of repeated printing of an image on a masking tape or the like.

In addition, the image forming apparatus according to the present embodiment also causes the method of processing the print tail end to be specifiable by the user, and thus, makes it possible to smoothly execute repeated printing for which the output print length has been specified.

### Variation 1

The image forming apparatus U according to the present disclosure may have an N-up function of performing N-up of document images in the width direction of the roll sheet P. The N-up function according to the present variation is a function of aggregating and printing document images as many as possible in the width direction of the roll sheet P. That is, in the image forming apparatus U according to the present variation, the controller 100 allows the user to specify the N-up of document images in the width direction of the roll sheet P in a print job.

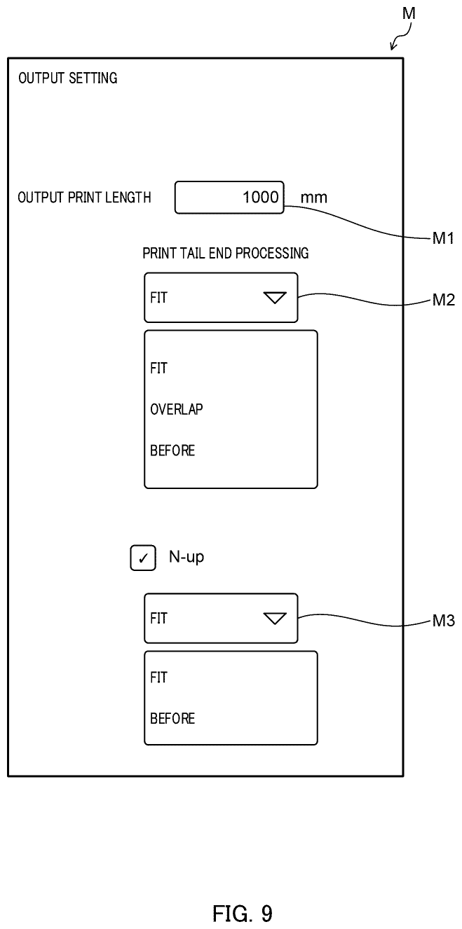

FIG. 9 is a diagram illustrating an example of the operation screen M for specifying the job content of a print job in the image forming apparatus U according to Variation 1.

On the operation screen M illustrated in FIG. 9, for example, an item (text box M1) for specifying the “output print length” and an item (pull-down menu M2) for specifying the “method of processing the print tail end” are displayed in the same manner as the operation screen M illustrated in FIG. 6, for example. In addition, on the operation screen M illustrated in FIG. 9, an item (check box M3) for specifying “N-up” and an item (pull-down menu M4) for specifying the “method of processing the print width end of the output sheet” are further displayed.

Then, for example, the user is allowed to specify N-up in a print job by setting up a check flag for the check box M3 of the operation screen M. In addition, for example, through selection from the pull-down menu M4 of the operation screen M, the user is allowed to specify one of two aspects, “fit” or “before”, as the method of processing the print width end at the time of N-up.

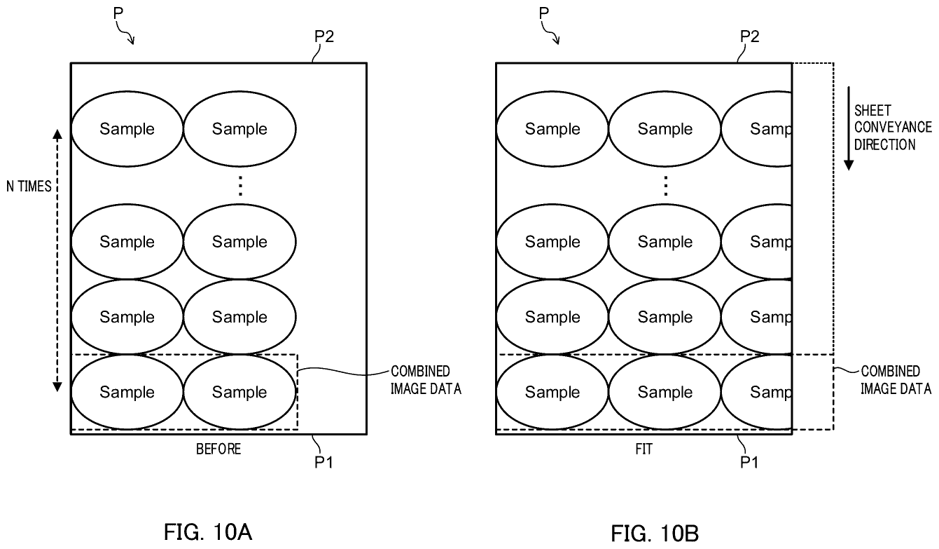

FIG. 10A and FIG. 10B are diagrams provided for describing a method of processing a print width end in the N-up function.

In a case where N-up has been specified in a print job, the controller 100 according to the present variation calculates the N-up number, which allows document images to be printed, based on the image horizontal size (indicating the image size in the conveyance direction; the same applies hereinafter) of a document image in the width direction and the sheet width size of the roll sheet P. Then, the controller 100 generates combined image data by combining the N-up number of document images in the width direction and causes the printing to be executed by using the combined image data.

Here, the controller 100 sets, as the N-up number, a value obtained by dividing the sheet width size of the roll sheet P by the image horizontal size of the document image, for example, as in an equation 2 below.

{3}

The n-up number=the sheet width size of the roll sheet P/the image horizontal size of the document image . . . (Equation 2)

In this respect, however, there is a case where when the N-up number is set, a print width end (representing an end of the roll sheet P in the width direction) does not coincide with a width end of a document image (representing an end of the document image in the width direction). This is because there is a case where the sheet width size of the roll sheet P does not coincide with the reference print width when document images are combined in the sheet width direction an integer number of times (where the integer number of times is a value obtained by performing floor division of the sheet width size by the image horizontal size). Note that, the “print width end” means a portion corresponding to an end of the roll sheet P in the width direction when repeated printing of a document image is performed on the roll sheet P along the width direction (the same applies hereinafter).

Accordingly, the controller 100 according to the present variation causes the method of processing a print width end to be specifiable in the function of N-up in a print job. Specifically, the controller 100 causes the number of repetitions for the document image or the like to be adjusted such that a print width end is subjected to processing according to the specified item “fit” or “before” (see FIG. 10A and FIG. 10B).

In a case where “before” has been specified here as the method of processing the print width end, the controller 100 sets the N-up number to the value calculated by performing floor division of the sheet width size of the roll sheet P by the image horizontal size of the document image as in FIG. 10A.

On the other hand, in a case where “fit” has been specified as the method of processing the print width end, the controller 100 sets the N-up number to a value calculated by ceiling division of the sheet width size of the roll sheet P by the image horizontal size of the document image as in FIG. 10B. Then, the controller 100 calculates the difference between the sheet width size and the above-described reference print width and correcting the image data of the outermost end of the roll sheet P to an image obtained by trimming the document image by the difference in the sheet width direction to generate combined image data.

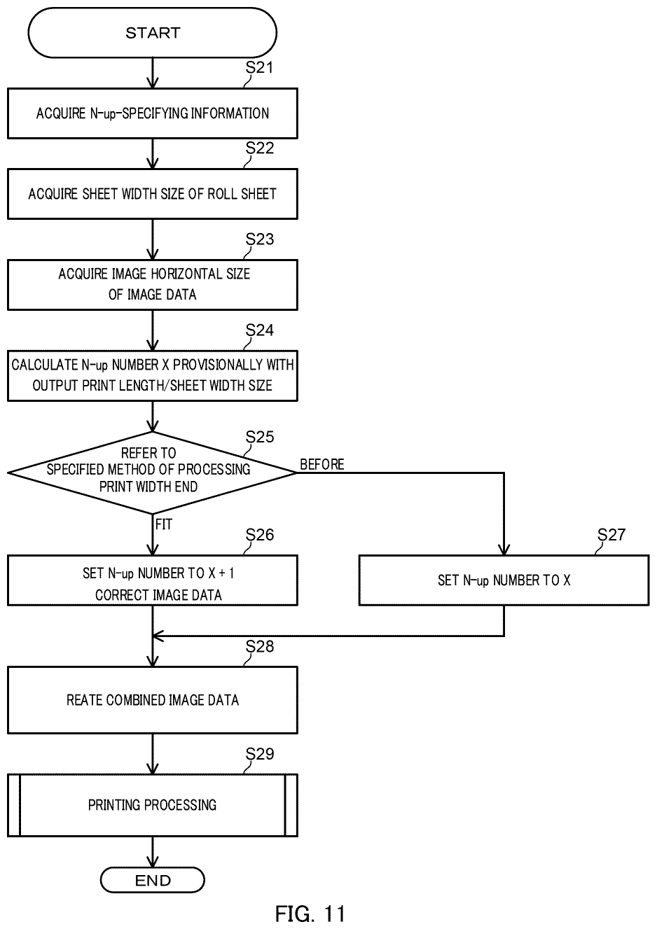

FIG. 11 is a flowchart illustrating an example of the operation of the controller 100 in the case of having the N-up function. FIG. 11 illustrates only a series of processing for generating combined image data.

First, the controller 100 acquires N-up-specifying information (whether N-up has been specified or not) in a print job (step S21). Next, the controller 100 acquires the sheet width size of the roll sheet P from the print data defining the print job (step S22). Next, the controller 100 acquires the image horizontal size of the document image in the sheet width direction of the document image from the print data defining the print job (step S23).

Next, the controller 100 calculates the required N-up number by performing floor division of the sheet width size of the roll sheet P by the image width size of the document image by using the following equation 2 (step S24).

{4}

The N-up number=the sheet width size of the roll sheet P/the image horizontal size of the document image . . . (Equation 2)

Next, the controller 100 refers to the “method of processing the print width end of the output sheet” specified in the print job (step S25).

In a case where the “before” mode has been specified here as the “method of processing the print width end portion of the output sheet” in the print job, the controller 100 determines the N-up number calculated by the equation 2 described above as the N-up number to be executed at the time of printing (step S27).

In addition, in a case where the “fit” mode has been specified here as the “method of processing the print width end portion of the output sheet” in the print job, the controller 100 determines a value obtained by incrementing the N-up number calculated by the equation 2 by one as the N-up number to be executed at the time of printing. Then, the controller 100 subtracts the N-up number×the image horizontal size from the sheet width size of the roll sheet P to calculate the difference therebetween. At this time, the controller 100 corrects the image data to be used for the outermost end of the roll sheet P to image data trimmed by the difference (step S26).

Next, the controller 100 combines the image data by the N-up number determined in S26 or S27 in the width direction to create combined image data (step S28).

Next, the controller 100 causes printing to be executed using the combined image data created in S28 so as to correspond to the specified output print length (step S29). Note that, the processing in step S29 is the same as the processing illustrated in the flowchart of FIG. 8.

By the series of processing as described above, the controller 100 is capable of causing repeated printing, for which N-up has been specified, to be executed.

### Variation 2

In the image forming apparatus U according to the present disclosure, in a print job, the output print length and the number of copies to be printed that defines the number of times of execution of printing with the output print length may also be configured to be specifiable.

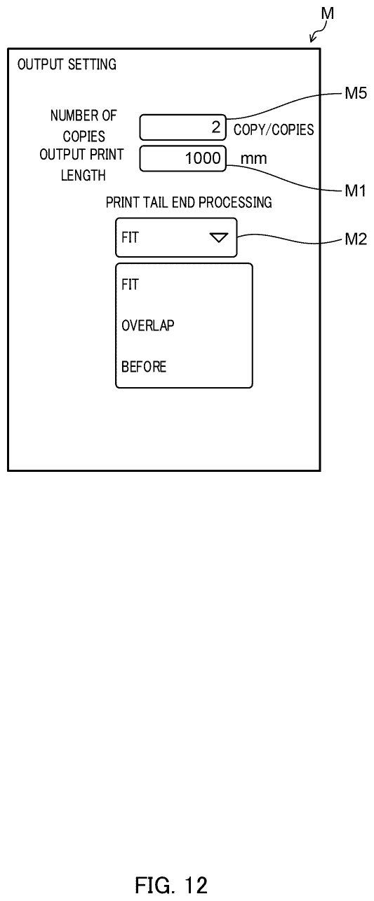

FIG. 12 is a diagram illustrating an example of the operation screen M for specifying the job content of a print job in the image forming apparatus U according to Variation 2.

On the operation screen M illustrated in FIG. 12, for example, an item (text box M1) for specifying the “output print length” and an item (pull-down menu M2) for specifying the “method of processing the print tail end” are displayed in the same manner as the operation screen M illustrated in FIG. 6, for example. In addition, on the operation screen M illustrated in FIG. 12, an item (text box M5) for specifying the number of copies to be printed is further displayed.

In the image forming apparatus U according to the present variation, a user is allowed to specify the number of times of execution of printing with the output print length by inputting the desired number of copies to be printed into the text box M5. The image forming apparatus U according to the present variation is useful, for example, as an image forming apparatus having a function of automatically replacing the roll sheet P.

### Variation 3

In configuring the image forming apparatus U according to the present disclosure, an operation display that gives an instruction to execute a print job may be mounted in an external terminal apparatus (for example, a computer used by the user).

That is, the function of the controller described in the above embodiment may be implemented in an image forming system including an image forming apparatus, which executes printing, and an external terminal apparatus, which receives an instruction to execute a print job. Thus, the user is allowed to use the external terminal apparatus to instruct the image forming apparatus U to execute a print job according to repeated printing of a document image after specifying the output print length and the like.

### Variation 4

When the image forming apparatus U according to the present disclosure is realized, the control for executing printing with an output print length may also be executed based on conveyance length information of the roll sheet P. The conveyance length information of the roll sheet P may be detected from the image read by the in-line scanner 70 or may be calculated from the number of rotations of the motor that drives the conveyance rollers of the sheet conveyor 50.

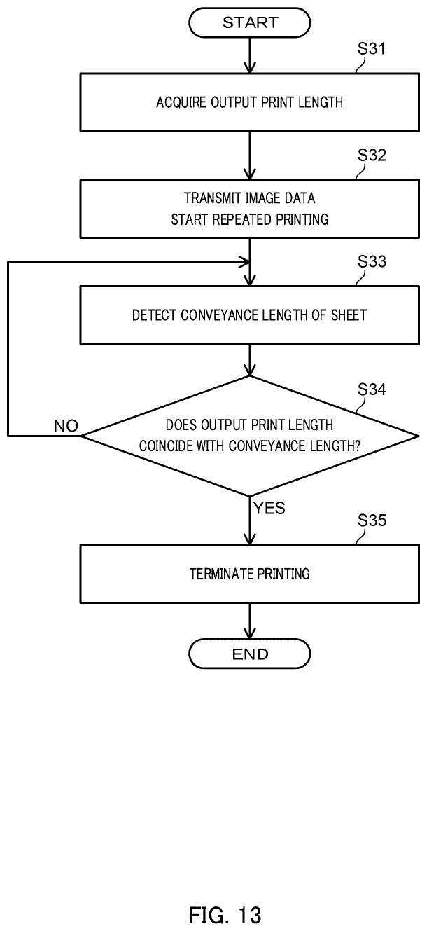

FIG. 13 is a flowchart illustrating an example of processing of the controller 100 in the image forming apparatus U according to the present variation.

First, the controller 100 acquires data of the specified output print length from the print data (step S31). Then, the controller 100 causes the image former 40 to start execution of repeated printing of the document image (step S32). Then, the controller 100 acquires information on the conveyance length of the roll sheet P from the sheet conveyor 50 (step S33). Then, the controller 100 determines whether or not the conveyance length of the roll sheet P has reached the specified output print length (step S34).

Then, the controller 100 repeats the processing in S33 and S34 and waits until the conveyance length of the roll sheet P reaches the specified output print length (step S34: NO). Then, in a case where the conveyance length of the roll sheet P has reached the specified output print length (step S34: YES), the controller 100 terminates the printing operation (step S35).

Even by the above-described processing, the controller 100 can control the image forming apparatus U such that a document image is repeatedly printed by the specified output print length. However, in the image forming apparatus U according to the present variation, there is a concern that the processing of the print tail end or the like cannot be appropriately performed. From this viewpoint, the image forming apparatus U according to the above-described embodiment is useful.

Although embodiments of the present invention have been described and illustrated in detail, the disclosed embodiments are made for purpose of illustration and example only and not limitation. The scope of the present invention should be interpreted by terms of the appended claims.

### Industrial Applicability

The image forming apparatus according to the present invention enables the user to specify a desired output print length and execute printing when repeatedly printing an image on a roll sheet.

What is claimed is:

1. An image forming apparatus of a roll-to-roll type, comprising
a hardware processor functioning as a controller that is capable of receiving an instruction to execute a print job according to printing of repeatedly printing a document image for which an output print length has been specified by an user and that, when receiving the instruction to execute the print job, causes the printing of the document image to be executed on a roll sheet a number of repetitions corresponding to the specified output print length, the roll sheet being a roll sheet to be conveyed.

2. The image forming apparatus according to claim 1, wherein
the controller sets the number of repetitions for repeatedly printing the document image in the print job based on an image vertical size of the document image in a sheet conveyance direction of the document image and the specified output print length and causes the printing to be executed.

3. The image forming apparatus according to claim 2, wherein
the controller allows the user to specify method of processing a print tail end of the roll sheet in the print job, the method being a method in a case where the specified output print length does not coincide with a reference print length required when the document image is repeatedly printed an integer number of times, the integer number of times being a value obtained by performing floor division of the output print length by the image vertical size.

4. The image forming apparatus according to claim 3, wherein the specifiable method of processing the print tail end includes a first aspect of setting the number of repetitions to a value calculated by ceiling division of the output print length by the image vertical size.

5. The image forming apparatus according to claim 3, wherein the specifiable method of processing the print tail end includes a second aspect of setting the number of repetitions to the value calculated by performing the floor division of the output print length by the image vertical size.

6. The image forming apparatus according to claim 3, wherein the specifiable method of processing the print tail end includes a third aspect of setting the number of repetitions to a value calculated by ceiling division of the output print length by the image vertical size, calculating a difference between the output print length and the reference print length, and correcting image data of a final page to image data obtained by trimming a side of a leading end of the document image in the sheet conveyance direction by the difference.

7. The image forming apparatus according to claim 1, wherein
the controller allows the user to specify the output print length and a number of copies to be printed in the print job, the number of copies to be printed defining a number of times of execution of the printing of the output print length.

8. The image forming apparatus according to claim 1, wherein
the controller causes the printing to be executed on the roll sheet by the specified output print length based on a conveyance length of the roll sheet to be conveyed.

9. The image forming apparatus according to claim 1, wherein
the controller allows the user to specify execution of N-up of a plurality of the document images in a width direction of the roll sheet in the print job.

10. The image forming apparatus according to claim 9, wherein
in a case where the N-up has been specified in the print job, the controller calculates an N-up number based on an image horizontal size of the document image in a width direction of the document image and a sheet width size of the roll sheet, generates combined image data obtained by combining the N-up number of the document images in the width direction and causes the printing to be executed by using the combined image data, the N-up number being the maximum number of the document images that can be printed in the width direction of the roll sheet.

11. The image forming apparatus according to claim 10, wherein
the controller allows the user to specify a method of processing a print width end of the roll sheet in a function of the N-up in the print job, the method being a method in a case where the sheet width size does not coincide with a reference print width required when the plurality of the document images are combined in a sheet width direction an integer number of times, the integer number of times being a value obtained by performing floor division of the sheet width size by the image horizontal size.

12. The image forming apparatus according to claim 11, wherein the specifiable method of processing the print width end includes a fourth aspect of setting the N-up number to the value calculated by performing the floor division of the sheet width size by the image horizontal size.

13. The image forming apparatus according to claim 11, wherein the specifiable method of processing the print width end includes a fifth aspect of setting the N-up number to a value calculated by ceiling division of the sheet width size by the image horizontal size as well as calculating a difference between the sheet width size and the reference print width and correcting image data of an outermost end of the roll sheet to an image obtained by trimming the document image by the difference in the sheet width direction to generate the combined image data.

14. The image forming apparatus according to claim 1, further comprising an operation display that allows the user to specify a job content of the print job.

15. An image forming system, comprising:
an external terminal apparatus that gives the instruction to execute the print job; and
the image forming apparatus according to claim 1.

16. A control method for an image forming apparatus of a roll-to-roll type, the method enabling reception of an instruction to execute a print job according to printing of repeatedly printing a document image for which an output print length has been specified by an user, the method comprising, when receiving the instruction to execute the print job, executing the printing of the document image on a roll sheet a number of repetitions corresponding to the specified output print length, the roll sheet being a roll sheet to be conveyed.

17. A non-transitory recording medium storing therein computer-readable program for image forming apparatus for an image forming apparatus of a roll-to-roll type, the control program enabling reception of an instruction to execute a print job according to printing of repeatedly printing a document image for which an output print length has been specified by an user, the control program causing a computer to execute, when receiving the instruction to execute the print job, the printing of the document image on a roll sheet a number of repetitions corresponding to the specified output print length, the roll sheet being a roll sheet to be conveyed.
